(19) United States
(12) Patent Application Publication
(10) Pub. No.: US 2023/0091515 A1
(43) Pub. Date: Mar. 23, 2023

(54) MODULAR PLATFORMS AND BIOASSEMBLY SYSTEMS

(71) Applicant: Advanced Solutions Life Sciences, LLC, Louisville, KY (US)

(72) Inventors: Scott Cambron, Louisville, KY (US); Brian Stuecker, Louisville, KY (US)

(73) Assignee: Advanced Solutions Life Sciences, LLC, Louisville, KY (US)

(21) Appl. No.: 17/932,322

(22) Filed: Sep. 15, 2022

Related U.S. Application Data
(60) Provisional application No. 63/244,513, filed on Sep. 15, 2021.

(51) Int. Cl. B29C 64/245; B29C 64/386; B33Y 30/00; B33Y 50/00

(52) U.S. Cl. CPC B29C 64/245; B29C 64/386; B33Y 30/00; B33Y 50/00

(57) ABSTRACT

A modular platform for a bioassembly system includes a platform frame and one or more removable stage inserts. The frame has a receiving portion and one or more frame electrical connections. Each removable stage insert is respectively configured to be received in the receiving portion of the platform frame in an inserted position. Each removable stage insert includes one or more insert electrical connections communicatively coupled to the one or more frame electrical connections when in the inserted position. The bioassembly system also includes a controller and a communicatively coupled memory including machine-readable instructions.

### PRIORITY CLAIM

This application claims the benefit of U.S. Provisional Application No. 63/244,513, filed on Sep. 15, 2021, the entirety of which is incorporated herein by reference.

### TECHNICAL FIELD

The present application generally relates to bioassembly systems and, more specifically, to modular platforms for bioassembly systems.

### BACKGROUND

Print beds, stages, and platforms are commonly used in additive and subtractive manufacturing, onto which a biomaterial is printed and dispensed in bioprinting. For example, additive manufacturing apparatuses may be utilized to build an object from building material, such as organic or inorganic powders, hydrogels, or solutions in a layer-wise manner. Tissue engineering via 3D biomaterial dispenser-based deposition, in particular, is a fast-evolving technology. Accordingly, a need exists for more efficient and accurate bioassembly systems for use in bioprinting.

### SUMMARY

In one embodiment, a modular platform for a bioassembly system may include a platform frame and one or more removable stage inserts. The platform frame has a receiving portion and one or more frame electrical connections. Each removable stage insert is respectively configured to be received in the receiving portion of the platform frame in an inserted position. Each removable stage insert includes one or more insert electrical connections communicatively coupled to the one or more frame electrical connections when in the inserted position. Each removable stage insert includes a unique identification chip communicatively coupled to the one or more insert electrical connections and configured to store information associated with the removable stage insert.

In another embodiment, a bioassembly system may include a controller, a memory communicatively coupled to the controller and comprising machine-readable instructions, and a modular platform. The module platform includes a platform frame and one or more removable stage inserts. The platform frame has a receiving portion and one or more frame electrical connections communicatively coupled to the controller. Each removable stage insert is respectively configured to be received in the receiving portion of the platform frame in an inserted position. Each removable stage insert includes one or more insert electrical connections communicatively coupled to the one or more frame electrical connections when in the inserted position. Each removable stage insert includes a unique identification chip communicatively coupled to the one or more insert electrical connections and configured to store information associated with the removable stage insert.

In yet another embodiment, a bioassembly system may include a controller, a memory, and a modular platform. The memory is communicatively coupled to the controller and includes machine-readable instructions. The modular platform includes a platform frame having a receiving portion and one or more frame electrical connections communicatively coupled to the controller. The modular platform further includes one or more removable stage inserts. Each removable stage insert is respectively configured to be received in the receiving portion of the platform frame in an inserted position. Each removable stage insert includes one or more insert electrical connections communicatively coupled to the frame one or more electrical connections when in the inserted position. The platform frame includes at least one alignment component, and each removable stage insert includes at least one corresponding alignment component. When a removable stage insert of the one or more removable stage inserts is in the inserted position, the at least one alignment component of the platform frame is configured to align with the at least one corresponding alignment component of the removable stage insert and block rotational movement of the removable stage insert.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a bioassembly system, according to one or more embodiments shown and described herein;

FIG. 2A depicts a front perspective view of a modular platform including a removable stage insert and a platform frame in a separated position, according to one or more embodiments shown and described herein;

FIG. 2B depicts a front perspective view of the removable stage insert of FIG. 2A in an inserted position with respect to the platform frame of FIG. 2A, according to one or more embodiments shown and described herein;

FIG. 3A depicts a front perspective view of another platform frame, according to one or more embodiments shown and described herein;

FIG. 3B depicts a front perspective view of another modular platform including the removable stage insert of FIG. 2A in an inserted position with respect to the platform frame of FIG. 3A, according to one or more embodiments shown and described herein;

FIG. 4A depicts a front perspective view of yet another modular platform including the platform frame of FIG. 2A and a removable stage insert with a temperature control unit, the removable stage insert in a separated position from the platform frame, according to one or more embodiments shown and described herein;

FIG. 4B depicts a rear perspective view of the removable stage insert of FIG. 4A;

FIG. 4C depicts a bottom-up side perspective view of the removable stage insert of FIG. 4A;

FIG. 4D depicts a bottom plan view of the removable stage insert of FIG. 4A;

FIG. 4E depicts a partially transparent perspective bottom-up side view of the removable stage insert of FIG. 4A;

FIG. 4F depicts a cross sectional view of the removable stage insert of FIG. 4A taken along a line 4F-4F in FIG. 4E; and

FIG. 5 depicts a front perspective view of yet another modular platform including the platform frame of FIG. 2A and a removable stage insert with a ventilation unit, the removable stage insert in a separated position from the platform frame, according to one or more embodiments shown and described herein.

### DETAILED DESCRIPTION

Modular platforms for bioassembly systems and the bioassembly systems described herein may improve functionality of printing stages and platforms for, but not limited to, bioprinting and biofabrication. The modular platforms may allow a user to quickly and easily remove a removable stage insert that may be used for printing bioinks or constructs within a wellplate, a petri dish, or a substrate holder. A removable stage insert may be replaced to another removable stage insert. By way of example, and not as a limitation, a removable stage insert without temperature control features removably coupled to a platform frame to form a modular platform may be replaced with another removable stage insert including temperature control features. Each removable stage insert may be received in the platform frame that provides a secure and positioned staging location for a bioassembly system. The removable stage insert and the platform frame may be electrically coupled when joined to permit power, control, and communication to be delivered to the removable stage insert and within the bioassembly system. As will be described in greater detail further below, the removable stage insert may have a unique identification chip in which information associated with the removable stage insert is saved and stored. The unique identification chip may be programmable to effectively power and communicate the identification of the removable stage insert to the bioassembly system without loss of information. The removable stage insert may include a coupling feature (e.g., a magnet, a latch, or the like) for pulling and holding the stage insert down for positioning or effective coupling between the stage insert and the platform frame. Various embodiments of the modular platforms and bioassembly systems will be described in more detail herein.

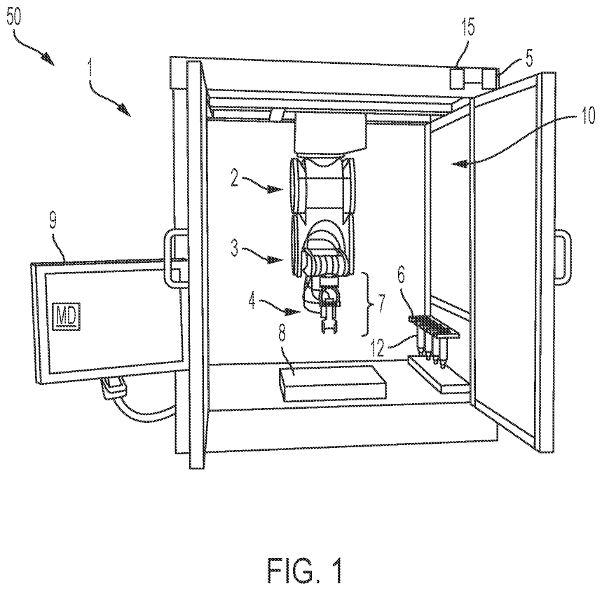

FIG. 1 generally depicts a bioassembly system 50. In embodiments, the bioassembly system 50 includes a framed housing 1 including a multi-axis robot 2, a controller 5, a material storage unit 6, a material dispensing unit 7, a print stage 8, a user interface 9, and a memory 15 communicatively coupled to the controller 5. As shown in FIG. 1, the multi-axis robot 2 may include a robotic arm 3 having a robotic arm effector component 4. The multi-axis robot 2 may operate as described in U.S. Pat. No. 11,112,769, titled “SYSTEM AND WORKSTATION FOR THE DESIGN, FABRICATION AND ASSEMBLY OF BIO-MATERIAL CONSTRUCTS,” assigned to Advanced Solutions Life Sciences, LLC, and which is hereby incorporated by reference in its entirety. The robotic arm effector component 4 may include an end effector configured to grip and secure a dispensing syringe, wherein the robotic arm provides movement of the syringe along one or more axes. As a non-limiting example, the multi-axis robot 2 may be a six-axis robot, and the ability to move along six axes may increase degree of freedom of the multi-axis, in particular with respect to printing on 3-D print substrates. Bio-constructs may be fabricated, for example, by dispensing biomaterial onto a print substrate such as on or atop the print stage 8. With six axes, biomaterials may be dispensed by non-sequential planar layering such that the robot effector may return to a prior layer and add more biomaterial after dispensing a subsequent layer. Further, the robotic arm effector component 4 is capable of aligning a dispenser/syringe tip at an angle normal to any point on a contoured surface. It is noted that the bioassembly system 50 is not limited to 3-D printing of biomaterials, but may be utilized for 2-D printing or printing with other applicable materials.

The multi-axis robot 2 may receive assembly steps and information from the controller 5. The multi-axis robot 2 may dispense of a biomaterial 12 with respect to a surface of a printing substrate on or atop the print stage 8. The multi-axis robot may retrieve the biomaterial 12 from the material storage unit 6. In embodiments, the material dispensing unit 7 includes extrusion syringe dispensers adapted for direct-writing the biomaterial 12 onto a substrate.

Generally, the material dispensing unit 7 comprises multiple syringes, each syringe containing a material (e.g., the biomaterial 12) and dispensing the material. The material storage unit 6 comprises at least one syringe barrel holder. Each syringe barrel holder includes multiple syringe barrels.

In embodiments, the material dispensing unit 7 further includes automatic tool exchange functionality for effectuating automated exchange of tools at the robotic arm effector component 4 as dictated by the print and/or assembly command from the controller 5. The robotic arm effector component 4 of the robotic arm 3 may include one or more effectors selected from printing tools, staging and assembling tools, and sensors. The printing tools may be selected from a gripper, a syringe barrel, adapting holder, and a dispenser. Staging and assembling tools may be selected from picking, placing, and positioning tools, and sensors are selected from a laser displacement sensor and a photoelectric sensor.

The print stage 8 may be adjustable and include a leveling mechanism that adjusts the level of the print stage 8. A laser displacement sensor may be located on the robotic arm effector component 4 to enhance a manual or automatic leveling protocol. Staging in accordance with embodiments may include picking and placing a print substrate onto the print stage 8. Printing is then effectuated on the substrate, which in specific embodiments may include variable surface topographies designed according to needs of specialized constructs. Assembling an ultimate biological construct may be effectuated by, for example, picking and positioning a first printed construct relative to a second construct, the second construct selected from a second printed construct and a provided construct. The print stage 8 may be partitioned into areas, for example, a print area and an assembly area. Non biological constructs may be included for assembly with biological constructs. Medical devices and jigs may be comprised entirely of non-biological materials. However, fabrication may proceed similarly and advantages conferred by the bioassembly system for the fabrication of biological constructs also generally apply to non-biological constructs.

In embodiments, the framed housing 1 is operationally accessible to a user from multiple angles and provides at least one real-time observation access. The bioassembly system 50 may further include a camera 10 as a part of an intelligent visual feedback system to supplement empirical observation and/or to provide remote viewing options, as well as the ability to stop a print and/or assembly process and make adjustments. The user interface 9 may stream a video feed from the camera 10.

In embodiments, the bioassembly system 50 includes a tissue modeling component and a robotic bioassembly component. The bioassembly system 50 may be an integrated solution for tissue structure modeling, fabrication, and assembly including a software component referred to herein as a Tissue Structure Information Modeling (TSIM). TSIM may allow clinicians and scientists to design, visualize, simulate, and analyze three dimensional (3-D) computer models of complex biological constructs, including tissue structures created from traditional sources of medical imaging technology. TSIM may provide a computer-assisted-design (CAD) platform that is particularly suited for end-users without specific expertise in conventional CAD software.

Generally, TSIM comprises software and the user interface 9 including an object modeling environment. TSIM comprises several suites of tools for performing one or more object operations. Object modeling tools include but are not limited to tool suites for creating, editing, modeling, transforming, image property modulating, sketching, print supporting, simulating, material testing and combinations thereof. In embodiments, the user interface 9 includes a materials database MD in which objects are stored as an object list associated with specific materials and material use parameters. The software is executable by a machine to facilitate methods for designing volumetric models of biological constructs at the user interface 9 in what is referred to herein as an object modeling environment.

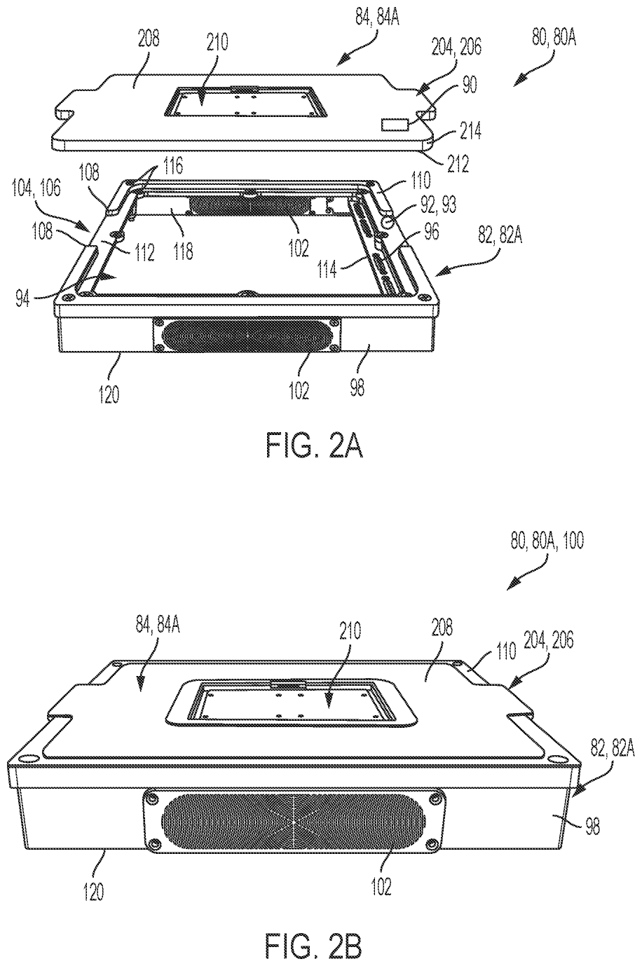

The memory 15 (e.g., a non-transitory, computer-readable storage medium) communicatively coupled to the controller 5 (e.g., a processor) may include one or more programming instructions as machine-readable instructions thereon that, when executed, cause the controller 5 to execute a control scheme, such as to receive an input via the user interface 9 and/or transmit a signal to the multi-axis robot 2 and/or a modular platform 80, which will be described in greater detail below with respect to FIGS. 2A-5. The modular platform 80 as described herein is able to be used as a print stage and in place of the print stage 8 of FIG. 1.

Referring now to FIGS. 2A-5, various embodiments of the modular platform 80 for the bioassembly system 50 are illustrated. The modular platform 80 (shown as modular platform 80A, 80B, 80C, 80D) generally includes a platform frame 82 (shown as platform frame 82A, 82B) and a removable stage insert 84 (shown as removable stage insert 84A, 84B, 84C, 84D).

FIGS. 2A-2C illustrate an embodiment of the modular platform 80, 80A including the platform frame 82, 82A and the removable stage insert 84, 84A insertable in the platform frame 82A. The removable stage insert 84A is shown in a separated position with respect to the platform frame 82A in FIG. 2A.

Referring to FIG. 2A, the platform frame 82A defines a receiving portion 94 configured to receive the removable stage insert 84A. The platform frame 82A further includes a latching mechanism 92, a magnet 93, one or more frame electrical connections 96, an outer wall 98, one or more grills 102 (that may include one or more fan elements), one or more alignment components 104, one or more receiving apertures 106, one or more walls 108, a top surface 110, an intermediate upper surface 112, a circuit ledge 114, one or more fasteners 116, an inner wall 118, and a bottom surface 120.

The removable stage insert 84, 84A includes a unique identification chip 90, Each removable stage insert 84 further includes, as shown in FIG. 2A for the removable stage insert 84A, an alignment component 204, a top surface 208, an intermediate portion 210, a bottom surface 212, and an outer wall 214. The alignment component 204 may be an indexing prong 206. The outer wall 214 is formed between the top surface 208 and the bottom surface 212. The bottom surface 202 is configured to rest against the intermediate upper surface 112 of the platform frame 82, 82A when the removable stage insert 84, 84A is received into the receiving portion 94 platform frame 82, 82A in an inserted position 100, as shown in FIG. 2B.

Referring again to the platform frame 82A of FIG. 2A, the one or more walls 108 of the platform frame 82A are formed between the top surface 110 and the intermediate upper surface 112. The wall including the intermediate upper surface 112 defines the receiving portion 94. The one or more walls 108 with a portion of the intermediate upper surface 112 define the one or more alignment components 104 to provide an alignment and indexing feature as described herein. As shown in FIG. 2A, the one or more alignment components 204 may be one or more receiving apertures 106. Each receiving aperture 106 may be configured to receive the indexing prong 206 of a corresponding alignment component 204 of the removable stage insert 84A, as will be described in greater detail further below.

The platform frame 82A may further include one or more components that are engaged to each other by the one or more fasteners 116 (e.g., bolts, screws, nuts, rivets, or the like). In embodiments, one or more coupling features, such as the latching mechanism 92, the magnet 93, or combinations of the latching mechanism 92 and the magnet 93 may be disposed on the intermediate upper surface 112 such that the removable stage insert 84, 84A is coupled to the platform frame 82, 82A in the inserted position 100 of FIG. 2B.

The one or more grills 102 of the platform frame 82A which may provide a heating, cooling, or ventilation function. The one or more grills 102 may be disposed between or on the outer wall 98 and the inner wall 118. The one or more grills 102 may be configured to force a flow of air across the platform frame 82A. The one or more grills 102 may include one or more inlets allowing air to flow therethrough.

The circuit ledge 114 may inwardly extend from a portion of the inner wall 118. The circuit ledge 114 includes the one or more frame electrical connections 96. A bottom surface 120 may be configured to be positioned in the bioassembly system 50. As a non-limiting example, the bottom surface 120 may be fixed or removably attached to a bottom area of the bioassembly system 50. In embodiments, the modular platform 80 may replace or be disposed on the print stage 8 in the bottom area of the bioassembly system 50. The bottom surface 120 may be supported by the print stage 8 such that the platform frame 82A and the print stage 8 may be leveled together when the print stage 8 is leveled by the leveling mechanism. Alternatively, the leveling mechanism may level the platform frame 82A independently.

Regarding the removable stage insert 84, 84A, the top surface 208 includes the intermediate portion 210 on which materials may be dispensed by the multi-axis robot 2 (FIG. 1) to be constructed into bio or non-bio constructs. For example, the intermediate portion 210 may hold a well plate or substrate holder. In embodiments, a footprint of the well plate may be 127×86 millimeters (mm). The substrate holders may include glass slides, petri dishes, or other suitable substrate holders. The removable stage insert 84, 84A includes the one or more corresponding alignment components 204 that may be the one or more indexing prongs 206. The indexing prongs 206 may be used as handles of the removable stage insert 84A for easy removal, replace, and insert. The indexing prongs 206 may further provide positioning and indexing features, which will be discussed in greater detail below with reference to FIG. 2B. The outer wall 214 that connects the top surface 208 and the bottom surface 212 of the removable stage insert 84A may provide positioning features as well. As such, the removable stage insert 84A provides surfaces of interest for dispensing on, precisely placing substrates on, and/or calibrating against. The removable stage insert 84A can be easily removed, serviced, and/or replaced with a different removable stage insert 84 of alternate function as described herein to thus form a modular platform 80 in conjunction with the platform frame 82.

In embodiments, instead of or in addition to the platform frame 82A having the one or more coupling features such as latching mechanism 92 and/or magnet 93, the coupling features may be disposed on a bottom surface 212 of the removable stage insert 84A to removably couple the removable stage insert 84A when inserted in the platform frame 82A. In embodiments, both of the platform frame 82A and the removable stage insert 84A have the one or more coupling features.

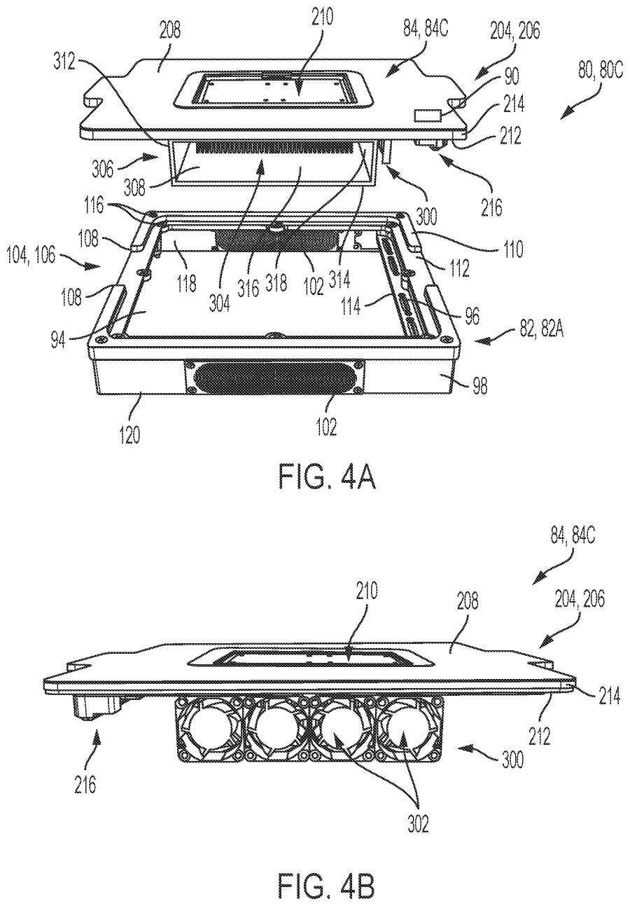

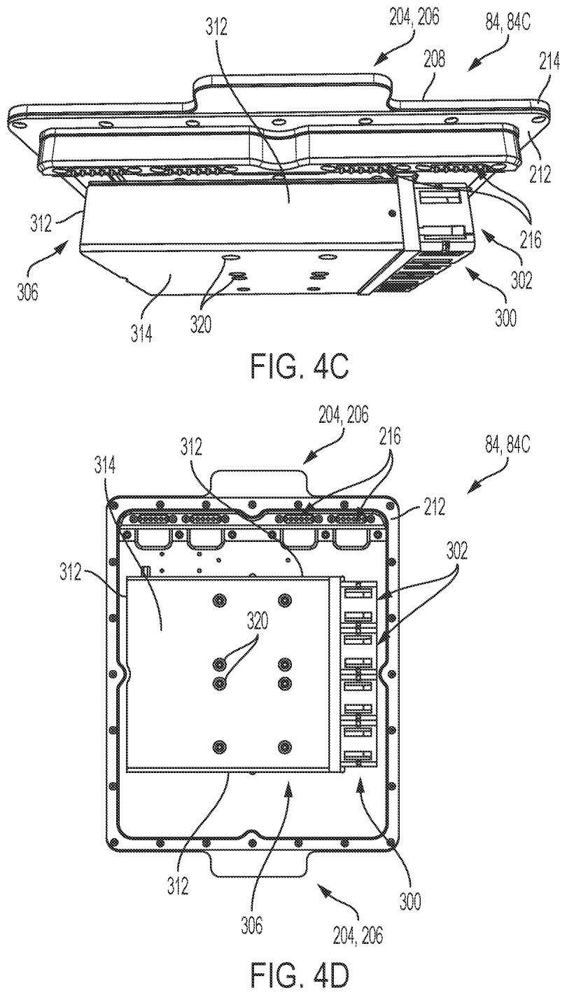

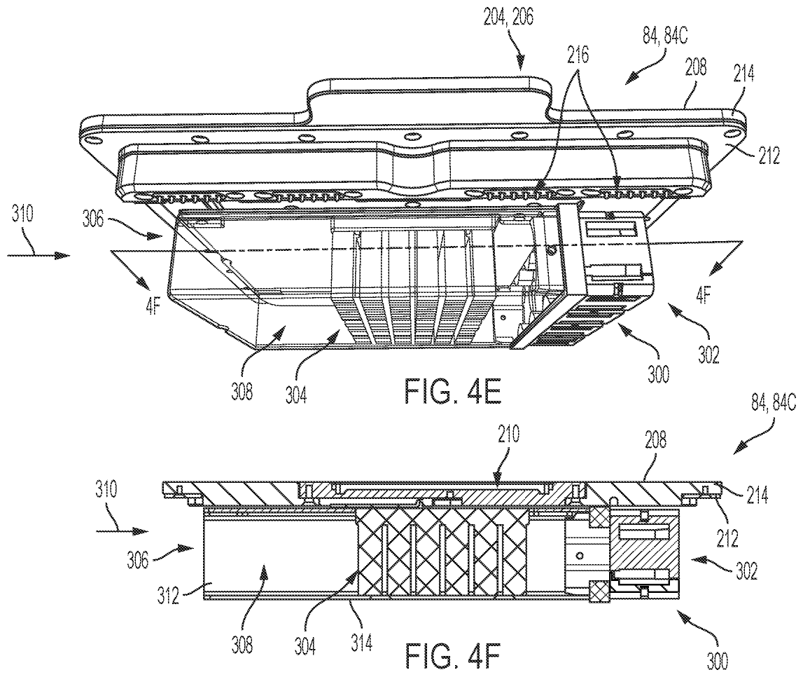

The removable stage insert 84, 84A further includes one or more insert electrical connections 216 (not shown in FIG. 2A, but shown in FIG. 4A-4E) disposed on the bottom surface 212 of the removable stage insert 84A. The removable stage insert 84A further the unique identification chip 90 communicatively coupled to the one or more insert electrical connections 216. The unique identification chip 90 is configured to store information associated with the removable stage insert 84A. For example, the information includes type/characteristic information, control information (e.g. temperature control information, level control information, or the like), lifecycle information, identification information (e.g., identification number, model number, or the like), or combinations thereof. The lifecycle information may be used to track the removable stage insert 84A for service and/or maintenance assistance.

Referring to FIG. 2B, the removable stage insert 84A is in the inserted position 100 with respect to the platform frame 82A. When in the inserted position 100, the removable stage insert 84A is disposed in the receiving portion 94. The one or more corresponding alignment components 204 are configured to align with the one or more alignment components 104, respectively and are configured as indexing features to block rotational movement of the removable stage insert 84A. For example, horizontal rotational movement of the removable stage insert 84A is blocked by the interference between at least one of the indexing prongs 206 and at least one of the walls 108 defining the receiving apertures 106 when the indexing prong 206 is received in the receiving aperture 106. Additionally, rotational movement of the removable stage insert 84A is blocked when the bottom surface 212 of the removable stage insert 84, 84A is received against the intermediate upper surface 112 of the platform frame 82, 82A.

In embodiments, the top surface 208 of the removable stage insert 84, 84A and the top surface 110 of the platform frame 82, 82A may be disposed in substantially the same plane when in the inserted position 100. Referring to FIGS. 2A and 2B, the bottom surface 212 of the removable stage insert 84A is disposed on the intermediate upper surface 112 of the platform frame 82A. The perimeter of the removable stage insert 84, 84A may match the inner profile of the platform frame 82, 82A to maintain a repeatable positional control. For example, the perimeter of the outer wall 214 matches the inner perimeter defined by the walls 108 inward of the receiving apertures 106.

When in the inserted position 100, the one or more frame electrical connections 96 are coupled to the one or more insert electrical connections 216 (not shown in FIG. 2A, but shown in FIG. 4A-4E). The removable stage insert 84, 84A is configured to receive electrical power from and communicate information associated with the removable stage insert 84, 84A to the bioassembly system 50 via the one or more frame electrical connections 96 when coupled and in the inserted position 100.

For example, the unique identification chip 90 of the removable stage insert 84A is configured to communicate the identification information to the controller 5 of the bioassembly system 50 (FIG. 1). Integrating the unique identification chip 90 within the removable stage insert 84, 84A allows programmable knowledge of what type of removable stage insert 84 is in the platform frame 82 at any time, which may enable software to effectively power and communicate to the removable stage insert 84 without issue or loss of information. In embodiments, the controller 5 may provide instructions to the bioassembly system 50 based on the identification information from the unique identification chip 90. The coupling features (e.g., the magnet 93, the latching mechanism 92) may effectively pull and/or hold down the removable stage insert 84 in the inserted position 100 to ensure proper electrical connections to permit power, control, and communication to be delivered to the removable stage insert 84.

In embodiments, the identification information may be used to verify an intended removable stage insert 84 (e.g., the removable stage insert 84A of FIG. 2B) is correctly inserted in the platform frame 82 (e.g., the platform frame 82A of FIG. 2B). When an unintended removable stage insert 84 is inserted in the platform frame 82, the bioassembly system 50 may send notifications. The bioassembly system 50 may stop further procedures until the intended removable stage insert 84 is inserted. In embodiments, the controller 5 may control the grills 102 to provide temperature identified in the identification information. The controller 5 may also control the multi-axis robot 2 to choose the biomaterial 12 associated with the identification information and further perform constructing steps based on the identification information, which may also include modeling instructions.

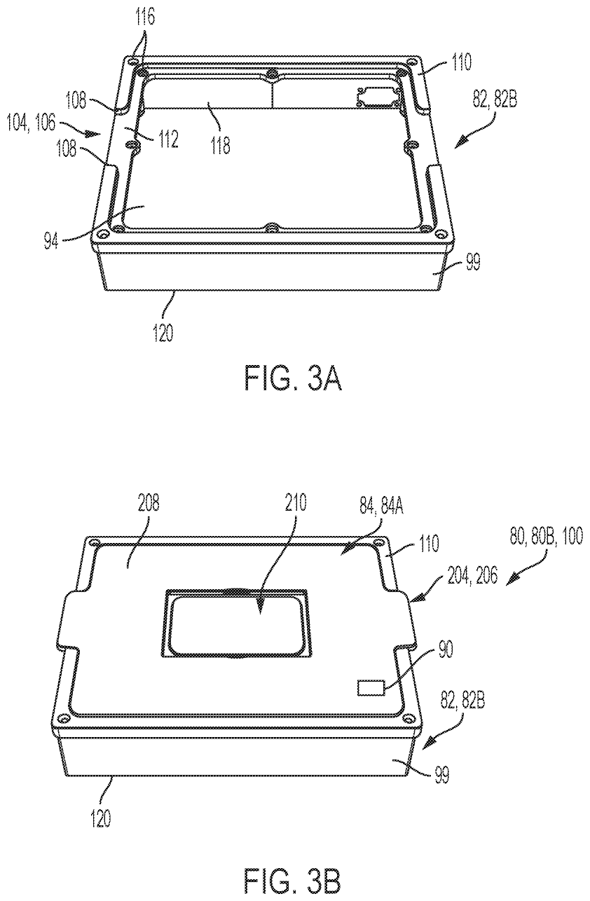

FIGS. 3A and 3B illustrate embodiments of a modular platform 80, 80B in which a platform frame 82B is used with the removable stage insert 84A to form the modular platform 80B. Referring to FIG. 3A, an embodiment of the platform frame 82B is illustrated. The platform frame 82B includes like components as described for the platform frame 82B though differently includes an outer wall skirt in place of the outer wall 98 or over the one or more grills 102 of FIGS. 2A-2B. While the platform frame 82B is not shown to include a circuit ledge (e.g., the circuit ledge 114 of the platform frame 82A), the platform frame 82B may similarly include such a circuit ledge. In embodiments, the platform frame 82B also is not shown to include one or more fan elements (e.g., the grills 102 of the platform frame 82A), though platform frame 82B may similarly include such grills 102. The platform frame 82B has an outer wall skirt 99 which constitutes a solid wall. The outer wall skirt 99 may provide aesthetic coverage to the entire modular platform 80B while providing a space to place vents or other pass-throughs, whether fluidic or electrical, for improved performance, thermal or otherwise.

Referring to FIG. 3B, the removable stage insert 84A is in the inserted position 100 with respect to the platform frame 82B. When in the inserted position 100, the removable stage insert 84A is disposed in the receiving portion 94 of the platform frame 82B. The one or more corresponding alignment components 204 are configured to align with the one or more alignment components 104, respectively, in the inserted position 100 and are configured to block rotational movement of the removable stage insert 84A with respect to the platform frame 82B.

FIGS. 4A-4F illustrates an embodiment of a modular platform 80, 80C with a removable stage insert 84C for receipt within the platform frame 82, 82A. FIG. 4A is a front view of the modular platform 80C showing the front side of the removable stage insert 84C and the platform frame 82A. The platform frame 82A includes the receiving portion 94 configured to receive the removable stage insert 84C. The receiving apertures 106 are configured to receive a corresponding indexing prong 206 of the removable stage insert 84C. Since the detailed description of the platform frame 82A has been made above with reference to FIGS. 2A-2B, the repeated explanation is omitted.

As described above, the top surface 208 of the removable stage insert 84, 84C includes the intermediate portion 210 on which materials are dispensed by the multi-axis robot 2 (FIG. 1) to be constructed into bio or non-bio constructs. For example, the intermediate portion 210 may hold a well plate, a petri dish, or a substrate holder. The removable stage insert 84, 84C includes one or more corresponding alignment component 204 including one or more indexing prongs 206. The indexing prongs 206 may be used as handles of the removable stage insert 84C. An outer wall 214 connects the top surface 208 and a bottom surface 212 of the removable stage insert 84C. The removable stage insert 84C further includes one or more insert electrical connections 216 disposed on the bottom surface 212 of the removable stage insert 84C.

Different from the removable stage insert 84A of FIGS. 2A-2B and 3B, the removable stage insert 84C further includes a temperature control unit 300 and associated components. As shown in FIGS. 4A-4F, the temperature control unit 300 includes one or more fans 302 (FIG. 4B), a heat sink 304, a bottom unit portion 306, a duct area 308, outer side walls 312, outer bottom wall 314, inner bottom wall 316, inner side walls 318, and fasteners 320 (FIG. 4C). In embodiments, the temperature control unit 300 may be a resistive heater or a peltier device, which includes the heat sink 304 disposed in the bottom unit portion 306. The bottom unit portion 306 forms the duct area 308 surrounded and defined by the inner side walls 318 and the inner bottom wall 316. The bottom unit portion 306 further includes the outer bottom wall 314 and outer side walls 312. The temperature control unit 300 is receiving within the receiving portion 94 of the platform frame 82, 82A when in the inserted position 100. In embodiments for higher temperature application over 100 degrees Celsius, for example, a resistive heater may be used while for other temperature applications under 100 degrees Celsius, the peltier device may be used. Types of resistive heater may include foil, cartridge, metal ceramic, and metal ceramic with thermistor, or combinations thereof. When electrical current flows to a material that has some resistance, heat is created (e.g., via the resistive heater) as a result of friction as created by forces and collisions involving the charge carriers. The generated heat corresponds to work done by the charge carriers to travel to a lower potential. A resistance of a conductor may be chosen to produce a certain amount of resistive heating.

The peltier device may sue electrothermal modules (ETMs), which may be thermoelectric generators, such as Seebeck generators. Seebeck generators convert temperature differences directly into electrical energy (e.g., through a Seebeck effect phenomenon in which a temperature differential between two electrically connected junctions produces an electromagnetic force between the junctions). Seebeck generators may operate in reverse such that applying a voltage to the device can cause it to act as a heater or cooler, depending on the magnitude and polarity of the voltage (e.g., through a Peltier effect phenomenon in which voltage applied across two electrically connected junctions produces a temperature differential between the junctions).

By being used with the platform frame 82A including the one or more grills 102 in an embodiment, the removable stage insert 84C with the temperature control unit 300 may provide efficient temperature control in conjunction with the one or more grills 102. For example, air entered through the grills 102 of the platform frame 82A may flow into the duct area 308 and further flow through the heat sink 304. The air may eventually exit from the grills 102. The air may be heated or cooled depending on the type of temperature control unit 300 used in embodiments. However, the temperature control unit 300 may provide efficient temperature control with other embodiments of the platform frame 82 as well.

FIG. 4B is a rear view of the removable stage insert 84C showing the opposite side (e.g., the back side) of the temperature control unit 300. In embodiments, the temperature control unit 300 may include the one or more fans 302 as shown in FIG. 4B. The fans 302 create air flow in the duct area 308 (FIG. 4A) to circulate air. For example, the fans 302 creates air flow flowing through the heat sink 304. The air may flow through the heat sink 304 (e.g., in a flow direction 310 as shown in FIGS. 4E-4F), and the fans 302 operate as blowers to draw the air out, such as toward the one or more grills 102 on a rear side of the platform frame 82A, which will be discussed in further detail below with reference to FIGS. 4E and 4F.

The unique identification chip 90 of the removable stage insert 84C may provide control information of the temperature control unit 300. The control information may include a target temperature, a threshold temperature, or a temperature range to be targeted during the control of the temperature control unit 300 by controlling the speed of the fans 302 or the temperature of the resistive heater or the peltier device.

FIG. 4C depicts a bottom-up side perspective view of the removable stage insert 84C. In FIG. 4C, a left to right direction corresponds to a front to rear direction of the removable stage insert 84C. In embodiments, the one or more insert electrical connections 216 include male connectors as shown in FIG. 4C, and corresponding frame electrical connections (e.g., frame electrical connections 96 of the platform frame 82A of FIG. 4A) include female connectors. Alternatively, in embodiments, the insert electrical connections 216 may include female connectors and corresponding frame electrical connections (e.g., frame electrical connections 96 of the platform frame 82A) may include male connectors. In additional or alternative embodiments, the removable stage insert 84C may be wirelessly coupled when inserted in a corresponding platform frame (e.g., various embodiments of the platform frame 82) in the inserted position 100 such that the unique identification chip 90 may be configured to wirelessly send information to the bioassembly system 50. For example, the one or more frame electrical connections 96 and the one or more insert electrical connections 216 may provide near field or BLUETOOTH wireless communication and/or power transfer.

In embodiments, the heat sink 304 may be coupled to the bottom unit portion 306 by the one or more fasteners 320 similar to those shown in FIGS. 4C-4D (e.g., bolts, screws, nuts, rivets, or the like). The fasteners 320 may further couple the bottom unit portion 306 to the bottom surface 212 of the removable stage insert 84C.

Referring to FIG. 4D, a bottom view of the removable stage insert 84C is shown. In FIG. 4D, a left to right direction corresponds to a front to rear direction of the removable stage insert 84C. In embodiments, the insert electrical connections 216 are disposed on one side of the bottom surface 212 of the removable stage insert 84C. The location of the insert electrical connections 216 is not limited to the one side, but may be the other side of the removable stage insert 84C or on one or more sides of the removable stage insert 84C.

Referring to FIGS. 4E and 4F, a partially transparent perspective bottom-up side view of the removable stage insert 84C is depicted in FIG. 4E in which the outer side wall 312 is made transparent for ease of viewing inner elements of the temperature control unit 300. A cross sectional view of the removable stage insert 84C taken along a line 4F-4F in FIG. 4E is depicted in FIG. 4F. In FIGS. 4E and 4F, a left to right direction corresponds to a front to rear direction of the removable stage insert 84C.

Referring to and as shown in FIGS. 4E and 4F, the heat sink 304 is disposed in the duct area 308. The heat sink 304 may be disposed spaced apart from the fans 302 to avoid direct contact with the fans 302. In embodiments, air may flow in a flow direction 310 (FIG. 4F). For example, the flow direction 310 may be parallel to a direction from the front end to the rear end of the temperature control unit 300. Fins of the heat sink 304 are oriented in a direction to accommodate air flow. For example, the fins may be oriented in the flow direction 310. The flow direction 310 may be parallel to the front to rear direction of the removable stage insert 84C. The fins of the heat sink 304 may be slotted to constitute multiple rows in the front to rear direction.

In embodiments, and as shown in FIG. 4F, the intermediate portion 210 may be disposed at a location corresponding to the heat sink 304. For example, the intermediate portion 210 may be disposed above the heat sink 304, which may provide efficient temperature control (e.g., heat exchange) for materials to be dispensed on the intermediate portion 210 or on the well plate or substrate holder to be disposed on the intermediate portion 210.

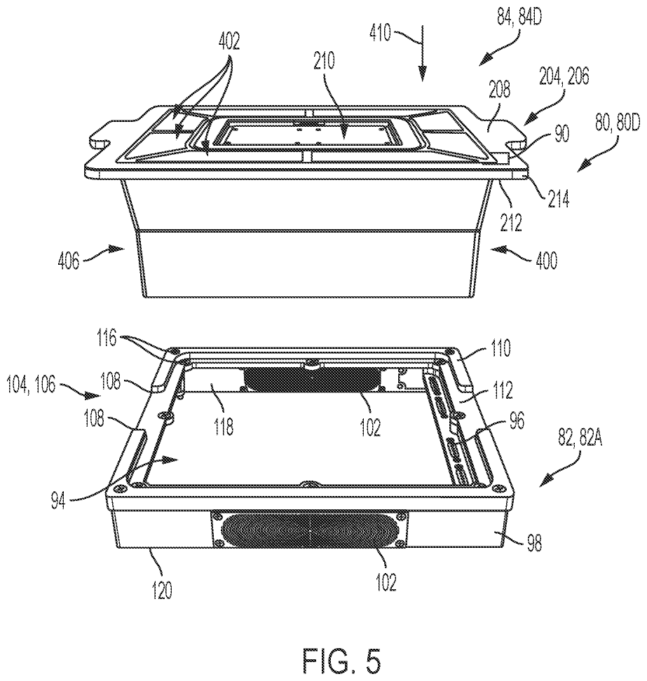

FIG. 5 illustrates an embodiment of the modular platform 80, 80D including the platform frame 82, 82A and a removable stage insert 84D that has a ventilation unit 400 insertable in the platform frame 82, 82A. The removable stage insert 84D is generally similar to the removable stage insert 84A of FIGS. 2A-2B and 3B, except for related to the ventilation unit 400 and components thereof as described below.

In embodiments, the ventilation unit 400 includes a bottom portion 406 and one or more ducts 402 defined along and by portions of the top surface 208 to draw air into and through the bottom portion 406. The ventilation unit 400 provides air flow in a flow direction 410. The flow direction 410 may be a top to bottom direction of the removable stage insert 84D.

The ventilation unit 400 may further include one or more fans to create air flow in the flow direction 410. The bottom portion 406 may be coupled to an additional ventilation device or duct to draw air away from the removable stage insert 84D. This may protect users from being exposed to the air that may contain harmful substances and/or may provide fresh air to the materials to be dispensed on the intermediate portion 210 or a well plate or substrate holder to be placed on the intermediate portion 210. The bottom portion 406 may provide aesthetic coverage to the removable stage insert 84D while providing a space to place vents or other pass-throughs, whether fluidic or electrical, for improved performance, thermal or otherwise. The ventilation unit 400 may be configured to provide filtration. For example, the ventilation unit 400 may include filters, such as carbon filters or high efficiency particulate air (“HEPA”) filters to absorb potential volatiles and/or particles.

It should be now understood that the various embodiments of modular platform 80 (80A, 80B, 80C, 80D) is not limited to the combinations discussed above. The modular platform 80 may constitute any combination of one of the various embodiments of the platform frames 82 (82A, 82B) and one of the various embodiments of the removable stage inserts 84 (84A, 84B, 84C, 84D). Therefore, the modular platform 80 may be easily tailored to specific purposes by replacing the removable stage inserts 84 (84A, 84B, 84C, 84D) and/or the platform frames 82 (82A, 82B) to meet such purposes. The platform frames 82 (82A, 82B) may provide a secure, precisely positioned, and repeatable staging location, and the removable stage inserts 84 (84A, 84B, 84C, 84D) may provide surfaces of interest for dispensing on, precisely placing substrates on, and/or calibrating against. Such removable stage inserts 84 can be easily removed, serviced, and/or replaced with a different removable stage insert 84 of an alternate function.

Thus, in embodiments as described herein, and with references to FIGS. 1-5, a modular platform 80, 80A, 80B, 80C, 80D for a bioassembly system 50 (FIG. 1) includes a platform frame 82, 82A, 82B and one or more removable stage inserts 84, 84A, 84C, 84D. The platform frame 82, 82A, 82B has the receiving portion 94 and the one or more frame electrical connections 96. Each removable stage insert 84, 84A, 84C, 84D is respectively configured to be received in the receiving portion 94 of the platform frame 82, 82A, 82B in the inserted position 100. Each removable stage insert 84, 84A, 84C, 84D further comprises one or more insert electrical connections 216 communicatively coupled to the one or more frame electrical connections 96 when in the inserted position 100. In some embodiments, the modular platform 80, 80A, 80B, 80C, 80D may be 10 inches by 12 inches, though other dimensions are within the scope of this disclosure. The platform frame 82, 82A, 82B may be made of aluminum, stainless steel, ceramic, another suitable materials, or combinations thereof. One or more portions of the removable stage insert 84, 84A, 84C, 84D may be made of various combinations of biocompatible materials, aluminum, stainless steel, ceramic, or another suitable materials.

In embodiments, each removable stage insert 84, 84A, 84C, 84D comprises a unique identification chip 90 communicatively coupled to the one or more insert electrical connections 216 and configured to store information associated with the removable stage insert 84, 84A, 84C, 84D. In additional or alternative embodiments, the platform frame 82, 82A, 82B comprises at least one alignment component 104, and each removable stage insert 84, 84A, 84C, 84D comprises at least one corresponding alignment component 204 such that when a removable stage insert 84, 84A, 84C, 84D of the one or more removable stage inserts 84, 84A, 84C, 84D is in the inserted position 100, the at least one alignment component 104 of the platform frame 82, 82A, 82B is configured to align with the at least one corresponding alignment component 204 of the removable stage insert 84, 84A, 84C, 84D and block rotational movement of the removable stage insert 84, 84A, 84C, 84D in the inserted position 100.

The at least one alignment component 104 of the platform frame 82, 82A, 82B may be one of a wall defining a receiving aperture (e.g., the receiving aperture 106) or an indexing prong (similar to the indexing prong 206), and the at least one corresponding alignment component 204 of the removable stage insert 84, 84A, 84C, 84D may be the other of the wall defining the receiving aperture (e.g., similar to the receiving aperture 106) or the indexing prong (e.g., the indexing prong 206). The indexing prong (e.g., the indexing prong 206) is configured for receipt within the receiving aperture (e.g., the receiving aperture 106) in the inserted position 100.

In aspects, one or more coupling features may be included in at least one of the platform frame 82, 82A, 82B or a removable stage insert of the one or more removable stage inserts 84, 84A, 84C, 84D such that, when the removable stage insert 84, 84A, 84C, 84D is in the inserted position 100, the removable stage insert 84, 84A, 84C, 84D is removably coupled to the platform frame 82, 82A, 82B. As described herein, the one or more coupling features may include the one or more magnets 93, the one or more latching mechanisms 92, or combinations thereof.

In embodiments, when a first removable stage insert of the one or more removable stage inserts 84, 84A, 84C, 84D is in the inserted position 100 with respect to the platform frame 82, 82A, 82B, the unique identification chip 90 of the first removable stage insert is configured to send the information associated with the first removable stage insert to the bioassembly system 50. The information associated with the first removable stage insert may include a type of the first removable stage insert, control information associated with the first removable stage insert, first removable stage insert life cycle information, or combinations thereof. The unique identification chip 90 of the first removable stage insert may be configured to send the information associated with the first removable stage insert to the bioassembly system 50 through the one or more frame electrical connections 96 of the platform frame 82, 82A, 82B when the inserted position 100. In aspects, the one or more frame electrical connections 96 are configured to transmit at least one of power, control information, or other communication between a removable stage insert of the one or more removable stage inserts 84, 84A, 84C, 84D and the platform frame 82, 82A, 82B when the removable stage insert is in the inserted position 100.

In embodiments, and as shown in FIGS. 4A-5, at least one removable stage insert of the one or more removable stage inserts 84, 84A, 84C, 84D may include a temperature control unit 300, a ventilation unit 400, or combinations thereof. The temperature control unit 300 may include a peltier device or a resistive heater, and the ventilation unit 400 may include one or more ducts 402 configured to connect to a vacuum system, one or more filters, or combinations thereof. In non-limiting examples, the one of more filters may include carbon filters, air filters, or other types and combinations of filters.

In aspects, and as described herein, the bioassembly system 50 further includes the controller 5 communicatively coupled to the removable stage insert 84, 84A, 84C, 84D. The controller 5 may be configured to control a removable stage insert of the one or more removable stage inserts 84, 84A, 84C, 84D when the removable stage insert is in the inserted position 100 based on the information stored in the unique identification chip 90 of the removable stage insert. The controller may be configured to identify a type of a removable stage insert of the one or more removable stage inserts 84, 84A, 84C, 84D when the removable stage insert is in the inserted position 100 based on information stored in the unique identification chip 90 of the removable stage insert.

The bioassembly system 50 may further include the memory 15 communicatively coupled to the controller and comprising machine-readable instructions to perform a control scheme as described herein. As a non-limiting example, the machine-readable instructions, when executed by the controller 5, may cause the controller to at least perform the following: send the information from the unique identification chip 90 associated with a first removable stage insert of the one or more removable stage inserts 84, 84A, 84C, 84D to the bioassembly system 50 when the first removable stage insert is in the inserted position 100 with respect to the platform frame 82, 82A, 82B. The information may include a type of the first stage insert, control information associated with the first stage insert, first stage insert life cycle information, or combinations thereof. The information may be sent at least one of wirelessly or via (e.g., a wired connection of) the one or more insert electrical connections 216 and the communicatively coupled one or more frame electrical connections 96 of the platform frame 82, 82A, 82B.

In embodiments, the controller 5 can be configured to sense whether items are disposed on the intermediate portion 210. The bioassembly system 50 may further operate with ambient air and/or with a temperature control that may be set by the controller 5 and/or with a vacuum system that may be controlled by the controller 5. The vacuum system may further operate as a coupling feature to drawn the removable stage inserts 84, 84A, 84C, 84D down to be held to the of the platform frame 82, 82A, 82B in the inserted position 100. The vacuum system may be a part of a heating, ventilation, and air conditioning (“HVAC”) system.

The various components of the bioassembly system 50 and the interaction thereof will be described in detail below. The bioassembly system 50 can comprise multiple servers containing one or more applications and computing devices. In some embodiments, the bioassembly system 50 is implemented using a wide area network (WAN) or network 222, such as an intranet or the internet. The computing device may include digital systems and other devices permitting connection to and navigation of the network. Other bioassembly system 50 variations allowing for communication between various geographically diverse components are possible. The lines depicted in FIG. 1 indicate communication rather than physical connections between the various components. The communication path shown by the lines may be formed from any medium that is capable of transmitting a signal such as, for example, conductive wires, conductive traces, optical waveguides, or the like, or from a combination of mediums capable of transmitting signals. The communication path communicatively couples the various components of bioassembly system 50. As used herein, the term “communicatively coupled” means that coupled components are capable of exchanging data signals with one another such as, for example, electrical signals via conductive medium, electromagnetic signals via air, optical signals via optical waveguides, and the like.

The controller 5 may be a processor, an integrated circuit, a microchip, a computer, or any other computing device communicatively coupled to the other components of the bioassembly system 50 by the communication path. Accordingly, the communication path may communicatively couple any number of controllers with one another, and allow the modules coupled to the communication path to operate in a distributed computing environment. Specifically, each of the modules can operate as a node that may send and/or receive data.

The memory 15 may be a non-transitory computer readable medium or non-transitory computer readable memory and may be configured as a nonvolatile computer readable medium. The memory 15 may comprise RAM, ROM, flash memories, hard drives, or any device capable of storing machine readable instructions such that the machine readable instructions can be accessed and executed by the controller 5. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory 15. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The bioassembly system 50 may include a display including a graphical user interface (GUI) on a screen of the computing device such as the user interface 9 described herein for providing visual output such as, for example, information, graphical reports, messages, or a combination thereof. The display on the screen of the computing device is coupled to the communication path and communicatively coupled to the controller 5. Accordingly, the communication path communicatively couples the display to other modules of the bioassembly system 50. The display can comprise any medium capable of transmitting an optical output such as, for example, a cathode ray tube, light emitting diodes, a liquid crystal display, a plasma display, or the like. Additionally, it is noted that the display or the computing device can comprise at least one of the controller 5 and the memory 15. While the bioassembly system 50 is illustrated as a single, integrated system in FIG. 1, in other embodiments, the systems can be independent systems.

### Aspects Listing

Aspect 1. A modular platform for a bioassembly system includes a platform frame and one or more removable stage inserts. The platform frame has a receiving portion and one or more frame electrical connections. Each removable stage insert is respectively configured to be received in the receiving portion of the platform frame in an inserted position. Each removable stage insert includes one or more insert electrical connections communicatively coupled to the one or more frame electrical connections when in the inserted position. Each removable stage insert includes a unique identification chip communicatively coupled to the one or more insert electrical connections and configured to store information associated with the removable stage insert.

Aspect 2. The modular platform of Aspect 1, wherein when a first removable stage insert of the one or more removable stage inserts is in the inserted position with respect to the platform frame, the unique identification chip of the first removable stage insert is configured to send the information associated with the first removable stage insert to the bioassembly system.

Aspect 3. The modular platform of Aspect 2, wherein the information associated with the first removable stage insert comprises a type of the first removable stage insert, control information associated with the first removable stage insert, first removable stage insert life cycle information, or combinations thereof.

Aspect 4. The modular platform of Aspect 2, wherein the unique identification chip of the first removable stage insert is configured to send the information associated with the first removable stage insert to the bioassembly system through the one or more frame electrical connections of the platform frame when the inserted position.

Aspect 5. The modular platform of any of Aspect 1 to Aspect 4, wherein the one or more frame electrical connections are configured to transmit at least one of power, control information, or other communication between a removable stage insert of the one or more removable stage inserts and the platform frame when the removable stage insert is in the inserted position.

Aspect 6. The modular platform of any of Aspect 1 to Aspect 5, further comprising a controller of the bioassembly system communicatively coupled to the removable stage insert.

Aspect 7. The modular platform of Aspect 6, wherein the controller is configured to control a removable stage insert of the one or more removable stage inserts when the removable stage insert is in the inserted position based on the information stored in the unique identification chip of the removable stage insert.

Aspect 8. The modular platform of Aspect 6 or Aspect 7, wherein the controller is configured to identify a type of a removable stage insert of the one or more removable stage inserts when the removable stage insert is in the inserted position based on information stored in the unique identification chip of the removable stage insert.

Aspect 9. The modular platform of any of Aspect 1 to Aspect 8, wherein the platform frame comprises at least one alignment component, and each removable stage insert comprises at least one corresponding alignment component such that when a removable stage insert of the one or more removable stage inserts is in the inserted position, the at least one alignment component of the platform frame is configured to align with the at least one corresponding alignment component of the removable stage insert and block rotational movement of the removable stage insert.

Aspect 10. The modular platform of Aspect 9, wherein the at least one alignment component of the platform frame comprises one of a wall defining a receiving aperture or an indexing prong, and the at least one corresponding alignment component of the removable stage insert comprises the other of the wall defining the receiving aperture or the indexing prong, wherein the indexing prong is configured for receipt within the receiving aperture in the inserted position.

Aspect 11. The modular platform of Aspect 9 or 10, further comprising one or more coupling features in at least one of the platform frame or a removable stage insert of the one or more removable stage inserts such that, when the removable stage insert is in the inserted position, the removable stage insert is removably coupled to the platform frame.

Aspect 12. The modular platform of Aspect 12, wherein the one or more coupling features comprises one or more magnets, one or more latching mechanisms, or combinations thereof.

Aspect 13. The modular platform of any of Aspect 1 to Aspect 12, wherein at least one removable stage insert of the one or more removable stage inserts comprises a temperature control unit, a ventilation unit, or combinations thereof.

Aspect 14. The modular platform of Aspect 13, wherein the temperature control unit comprises a peltier device or a resistive heater, and the ventilation unit comprises one or more ducts configured to connect to a vacuum system, one or more filters, or combinations thereof.

Aspect 15. A bioassembly system includes a controller, a memory communicatively coupled to the controller and comprising machine-readable instructions, and a modular platform. The module platform includes a platform frame and one or more removable stage inserts. The platform frame has a receiving portion and one or more frame electrical connections communicatively coupled to the controller. Each removable stage insert is respectively configured to be received in the receiving portion of the platform frame in an inserted position. Each removable stage insert includes one or more insert electrical connections communicatively coupled to the one or more frame electrical connections when in the inserted position. Each removable stage insert includes a unique identification chip communicatively coupled to the one or more insert electrical connections and configured to store information associated with the removable stage insert.

Aspect 16. The bioassembly system of Aspect 15, wherein the machine-readable instructions, when executed by the controller, cause the controller to at least send the information from the unique identification chip associated with a first removable stage insert of the one or more removable stage inserts to the bioassembly system when the first removable stage insert is in the inserted position with respect to the platform frame, wherein the information comprises a type of the first removable stage insert, control information associated with the first removable stage insert, first removable stage insert life cycle information, or combinations thereof.

Aspect 17. The bioassembly system of Aspect 16, wherein the information is sent at least one of wirelessly or via the one or more insert electrical connections and the communicatively coupled one or more frame electrical connections of the platform frame.

Aspect 18. The bioassembly system of any of Aspect 15 to Aspect 17, wherein the platform frame comprises at least one alignment component, and each removable stage insert comprises at least one corresponding alignment component such that when a removable stage insert of the one or more removable stage inserts is in the inserted position, the at least one alignment component of the platform frame is configured to align with the at least one corresponding alignment component of the removable stage insert and block rotational movement of the removable stage insert.

Aspect 19. A bioassembly system includes a controller, a memory, and a modular platform. The memory is communicatively coupled to the controller and includes machine-readable instructions. The modular platform includes a platform frame having a receiving portion and one or more frame electrical connections communicatively coupled to the controller. The modular platform further includes one or more removable stage inserts. Each removable stage insert is respectively configured to be received in the receiving portion of the platform frame in an inserted position. Each removable stage insert includes one or more insert electrical connections communicatively coupled to the frame one or more electrical connections when in the inserted position. The platform frame includes at least one alignment component, and each removable stage insert includes at least one corresponding alignment component. When a removable stage insert of the one or more removable stage inserts is in the inserted position, the at least one alignment component of the platform frame is configured to align with the at least one corresponding alignment component of the removable stage insert and block rotational movement of the removable stage insert.

Aspect 20. The bioassembly system of Aspect 19, wherein at least one removable stage insert of the one or more removable stage inserts comprises a temperature control unit, a ventilation unit, or combinations thereof.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Unless otherwise defined, all technical and scientific terms used herein have the same meaning as commonly understood by one of ordinary skill in the art to which this disclosure belongs. All publications, patent applications, patents, and other references mentioned herein are incorporated by reference in their entirety.

As used in this specification and the appended claims, the singular forms “a,” “an,” and “the” include plural references unless the context clearly dictates otherwise. Any reference to “or” herein is intended to encompass “and/or” unless otherwise stated.

As used herein, “biomaterial” means a liquid, semi-solid, or solid composition comprising a plurality of cells, cell solutions, cell aggregates, multicellular forms or tissues, and in all cases may include support material such as gels, hydrogels, alginate or non-cellular materials that provide specific biomechanical properties that enable biomaterial printing.

As used herein, “cartridge” means any object that is capable of receiving (and holding) a biomaterial and/or a support material and used interchangeably with “syringe barrel.”

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A modular platform for a bioassembly system, the modular platform comprising:
a platform frame having a receiving portion and one or more frame electrical connections; and
one or more removable stage inserts, each removable stage insert respectively configured to be received in the receiving portion of the platform frame in an inserted position, each removable stage insert comprising one or more insert electrical connections communicatively coupled to the one or more frame electrical connections when in the inserted position,
wherein each removable stage insert comprises a unique identification chip communicatively coupled to the one or more insert electrical connections and configured to store information associated with the removable stage insert.

2. The modular platform of claim 1, wherein when a first removable stage insert of the one or more removable stage inserts is in the inserted position with respect to the platform frame, the unique identification chip of the first removable stage insert is configured to send the information associated with the first removable stage insert to the bioassembly system.

3. The modular platform of claim 2, wherein the information associated with the first removable stage insert comprises a type of the first removable stage insert, control information associated with the first removable stage insert, first removable stage insert life cycle information, or combinations thereof.

4. The modular platform of claim 2, wherein the unique identification chip of the first removable stage insert is configured to send the information associated with the first removable stage insert to the bioassembly system through the one or more frame electrical connections of the platform frame when the inserted position.

5. The modular platform of claim 1, wherein the one or more frame electrical connections are configured to transmit at least one of power, control information, or other communication between a removable stage insert of the one or more removable stage inserts and the platform frame when the removable stage insert is in the inserted position .

6. The modular platform of claim 1, further comprising a controller of the bioassembly system communicatively coupled to the removable stage insert.

7. The modular platform of claim 6, wherein the controller is configured to control a removable stage insert of the one or more removable stage inserts when the removable stage insert is in the inserted position based on the information stored in the unique identification chip of the removable stage insert.

8. The modular platform of claim 6, wherein the controller is configured to identify a type of a removable stage insert of the one or more removable stage inserts when the removable stage insert is in the inserted position based on information stored in the unique identification chip of the removable stage insert.

9. The modular platform of claim 1, wherein the platform frame comprises at least one alignment component, and each removable stage insert comprises at least one corresponding alignment component such that when a removable stage insert of the one or more removable stage inserts is in the inserted position, the at least one alignment component of the platform frame is configured to align with the at least one corresponding alignment component of the removable stage insert and block rotational movement of the removable stage insert.

10. The modular platform of claim 9, wherein the at least one alignment component of the platform frame comprises one of a wall defining a receiving aperture or an indexing prong, and the at least one corresponding alignment component of the removable stage insert comprises the other of the wall defining the receiving aperture or the indexing prong, wherein the indexing prong is configured for receipt within the receiving aperture in the inserted position.

11. The modular platform of claim 9, further comprising one or more coupling features in at least one of the platform frame or a removable stage insert of the one or more removable stage inserts such that, when the removable stage insert is in the inserted position, the removable stage insert is removably coupled to the platform frame.

12. The modular platform of claim 11, wherein the one or more coupling features comprises one or more magnets, one or more latching mechanisms, or combinations thereof.

13. The modular platform of claim 1, wherein at least one removable stage insert of the one or more removable stage inserts comprises a temperature control unit, a ventilation unit, or combinations thereof.

14. The modular platform of claim 13, wherein the temperature control unit comprises a peltier device or a resistive heater, and the ventilation unit comprises one or more ducts configured to connect to a vacuum system, one or more filters, or combinations thereof.

15. A bioassembly system comprising:
a controller;
a memory communicatively coupled to the controller and comprising machine-readable instructions; and
a modular platform, the modular platform comprising:
a platform frame having a receiving portion and one or more frame electrical connections communicatively coupled to the controller; and
one or more removable stage inserts, each removable stage insert respectively configured to be received in the receiving portion of the platform frame in an inserted position, each removable stage insert comprising one or more insert electrical connections communicatively coupled to the one or more frame electrical connections when in the inserted position,
wherein each removable stage insert comprises a unique identification chip communicatively coupled to the one or more insert electrical connections and configured to store information associated with the removable stage insert.

16. The bioassembly system of claim 15, wherein the machine-readable instructions, when executed by the controller, cause the controller to at least send the information from the unique identification chip associated with a first removable stage insert of the one or more removable stage inserts to the bioassembly system when the first removable stage insert is in the inserted position with respect to the platform frame, wherein the information comprises a type of the first removable stage insert, control information associated with the first removable stage insert, first removable stage insert life cycle information, or combinations thereof.

17. The bioassembly system of claim 16, wherein the information is sent at least one of wirelessly or via the one or more insert electrical connections and the communicatively coupled one or more frame electrical connections of the platform frame.

18. The bioassembly system of claim 15, wherein the platform frame comprises at least one alignment component, and each removable stage insert comprises at least one corresponding alignment component such that when a removable stage insert of the one or more removable stage inserts is in the inserted position, the at least one alignment component of the platform frame is configured to align with the at least one corresponding alignment component of the removable stage insert and block rotational movement of the removable stage insert.

19. A bioassembly system comprising:
a controller;
a memory communicatively coupled to the controller and comprising machine-readable instructions; and
a modular platform, the modular platform comprising:
a platform frame having a receiving portion and one or more frame electrical connections communicatively coupled to the controller; and
one or more removable stage inserts, each removable stage insert respectively configured to be received in the receiving portion of the platform frame in an inserted position, each removable stage insert comprising one or more insert electrical connections communicatively coupled to the frame one or more electrical connections when in the inserted position,
wherein the platform frame comprises at least one alignment component, and each removable stage insert comprises at least one corresponding alignment component such that when a removable stage insert of the one or more removable stage inserts is in the inserted position, the at least one alignment component of the platform frame is configured to align with the at least one corresponding alignment component of the removable stage insert and block rotational movement of the removable stage insert.

20. The bioassembly system of claim 19, wherein at least one removable stage insert of the one or more removable stage inserts comprises a temperature control unit, a ventilation unit, or combinations thereof.
